(19) United States
(12) Patent Application Publication
(10) Pub. No.: US 2006/0070498 A1
(43) Pub. Date: Apr. 6, 2006

(54) Wrench socket

(76) Inventor: Nigel Alexander Buchanan, By Leven (GB)

Correspondence Address: OSTRAGER CHONG FLAHERTY & BROITMAN PC, 250 PARK AVENUE, SUITE 825, NEW YORK, NY, 10177, US

(21) Appl. No.: 10/545,125

(22) PCT Filed: Feb. 10, 2004
(86) PCT No.: PCT/GB04/00525

§ 371 Date: Aug. 9, 2005

(30) Foreign Application Priority Data
Feb. 10, 2003 (GB) 0303007.9

(51) Int. Cl. B25B 13/28; B25B 13/06

(52) U.S. Cl. 81/90.1; 81/121.1; 81/177.85

(57) ABSTRACT

A socket for use on fasteners, such as a locking nut inaccessible to closed sockets or ring wrenches, comprises a minimum of two swivel jaws pivotally mounted in the same plane, and fixed and secured together at a swivel end by an axis pin. Such locking nuts may be found, for example, on a tie rod (track rod) or tie rod end within a vehicle steering rack. The swivel jaws advantageously open and close as required around the fastener. Lock/drive portions, preferably in the form of apertures, align with each other and an appropriate drive spigot means is engaged into the lock/drive apertures to not only lock the swivel jaws closed around a polygonal drive surface of the fastener, but to provide a drive torque via a torque drive bar for operating the socket.

### FIELD OF INVENTION

This invention relates to a socket to be used with a handle as a wrench (in Great Britain wrenches are sometimes referred to as spanners) which can be used for the purpose of tightening or slackening various types of nuts, bolts or screws (hereinafter referred to as fasteners).

### BACKGROUND TO THE INVENTION

A head portion of a ring wrench or socket usually has an inner shape and size complimentary to that of a typically hexagonal or square fastener head. The head of such a socket or wrench has an inner surface which surrounds the fastener head with only a small amount of clearance between the inner surface of the socket or wrench head and fastener head. As torque is applied to the socket or wrench head the torque is transmitted to the fastener head to turn the fastener in the appropriate direction.

Sockets or ring type wrenches are preferable to open jaw type wrenches because the torque applied to the socket is transmitted to the fastener via a much larger contact area and the ring head of the socket or wrench can transmit far greater torque without harmful distortion of the fastener head and less chance of the socket or wrench head damaging or slipping off the fastener. Ring wrenches are preferable of the closed head type in order to transmit adequate torque to the fastener without the ring head opening under the applied torque causing damage or slippage. Closed ring sockets or wrenches, however, are incapable of use on pipe work fittings and fasteners where closed pipe work or other obstructions such as a vehicle tie rod prevent the fasteners being accessed. Likewise known sockets and their various operating means cannot be used for the same reason.

It is an object of the present invention to at least partially alleviate the above mentioned disadvantages, or to provide an alternative to existing products.

### SUMMARY OF THE INVENTION

According to the present invention there is provided a for operation by a torque applying device, comprising two arms connected for movement one relative to the other between a first position in which ends of the arms remote from the connection are spaced apart, and a second position in which co-operating portions of the ends of the arms remote from the connection are simultaneously engagable by the torque applying device to lock the arms together and secure a fastener drive surface defined between the arms.

In one embodiment in accordance with the present invention a socket includes two swivel jaws capable of pivotal movement in the same plane around an axis pin which also fixes and secures the swivel jaws together. When a fastener drive surface of the socket is closed around an appropriately sized fastener, interlocking lock/drive portions of the swivel jaws, at the ends of the arms remote from the interconnection, align with each other enabling an appropriately sized drive spigot of an operating bar to enter and engage both the swivel jaws by the lock/drive portions. The tie rod socket is thereby locked and held closed by the operating bar drive spigot providing an inherently strong closed ring head socket means which can be conveniently operated by an operating bar, socket bar or ratchet means to apply torque in the required direction to the fastener being operated.

In another preferred embodiment in accordance with the present invention the two swivel jaws are stepped at the axis pin portions and lock/drive portions so that the fastener drive portions, lock/drive portions and the fastener drive portions lie substantially parallel.

Preferably, the axis pin portions and lock/drive portions are interlocking but allow relative movement therebetween. The wrench lock/drive portions preferably comprise a square drive hole similar to that used by fastener sockets so that the socket can be operated by known socket operating means.

Preferably, a polygonal shaped fastener drive surface of the closed socket is shaped so that its contact with a polygonal drive surface of a fastener is via the parts of the flanks of each drive surface of the fastener best capable for transmitting torque in the direction of the torque applied.

Although this preferred embodiment is only capable of use in one direction, the improved profile of the swivel jaw fastener drive surface allows a range of near sized fasteners to be operated with confidence using the same socket drive.

### BRIEF DESCRIPTION OF THE EMBODIMENTS

Embodiments of the present invention, which are given by way of example only, will now be described by way of example with reference to the accompanying drawings in which:

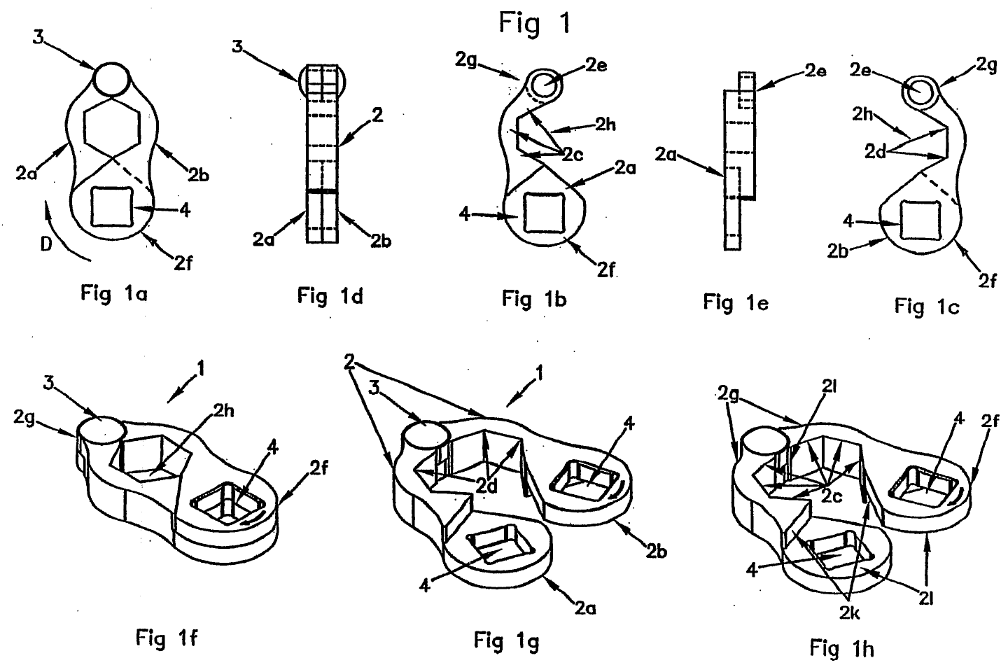

FIG. 1a is a top plan view of a closed socket in accordance with the present invention;

FIG. 1b is a top plan view of a left hand jaw portion of the socket of FIG. 1a;

FIG. 1c is a top plan view of a right hand jaw portion of the socket of FIG. 1a;

FIG. 1d is a side elevational view of the socket of FIG. 1a;

FIG. 1e is a side elevational view of the left hand jaw portion of FIG. 1b;

FIG. 1f is a perspective view of the closed socket of FIG. 1a;

FIG. 1g is a perspective view of the socket of FIG. 1a in an open position;

FIG. 1h is a perspective view of the socket of FIG. 1a in a second open position;

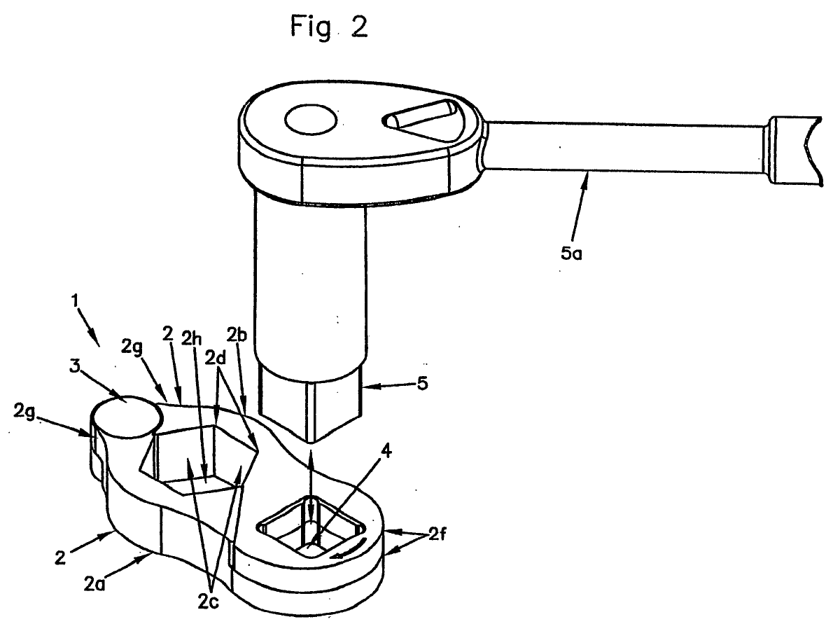

FIG. 2 is a perspective view of the closed socket of FIG. 1f, a drive spigot, and socket drive bar;

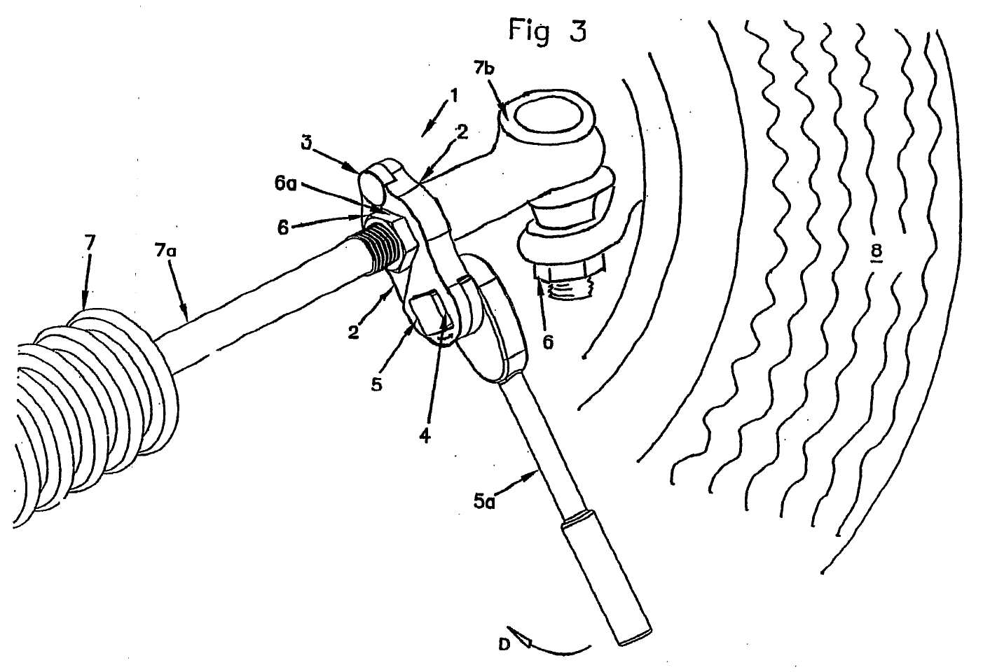

FIG. 3 is a perspective view of the closed socket, drive spigot and socket drive bar of FIG. 2 in operation upon a tie rod locking fastener;

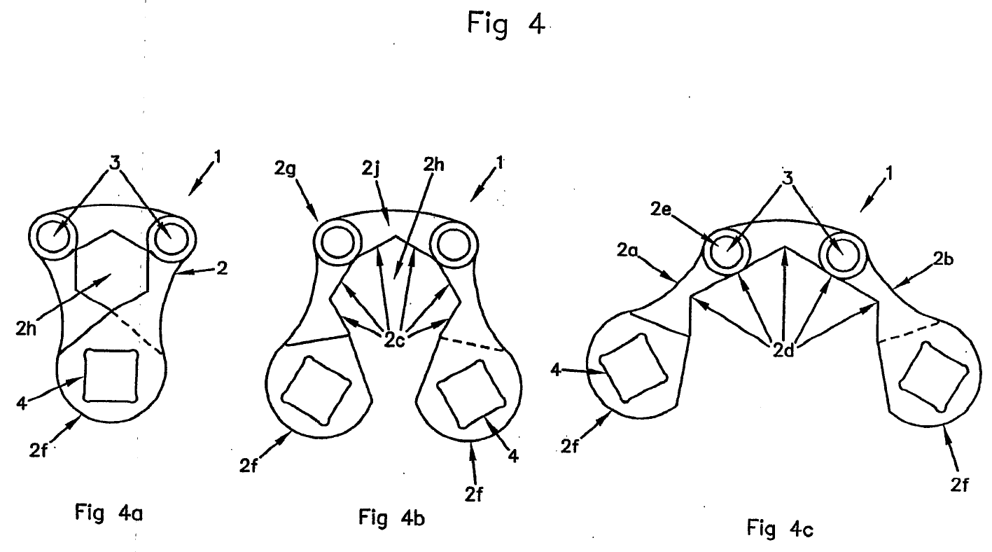

FIG. 4a is a top view of an alternative embodiment of a closed socket having more than two jaw portions;

FIG. 4b is a top view of the socket of FIG. 4a in one open position;

FIG. 4c is a top view of the socket of FIG. 4a in a second open position;

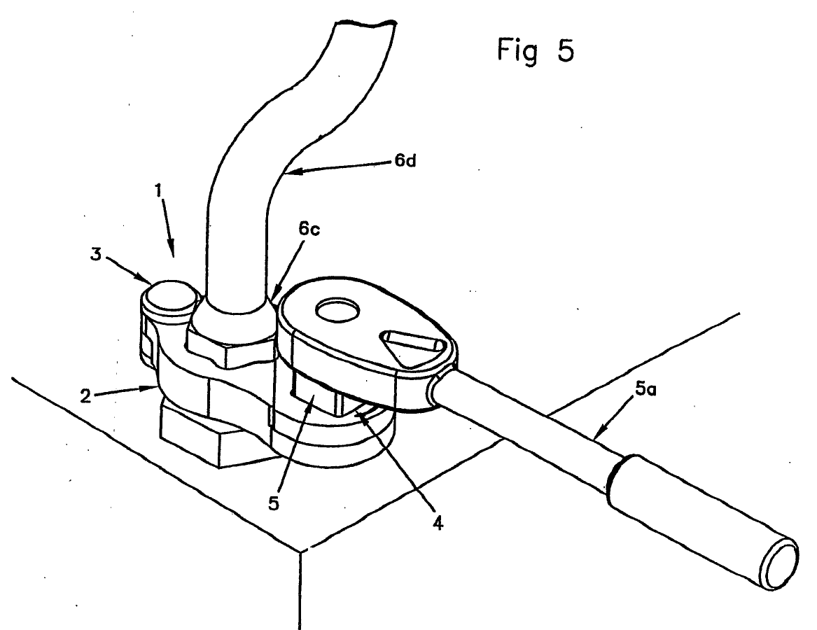

FIG. 5 shows the socket of FIG. 1a being used to tighten or slacken a pipe fitting; and

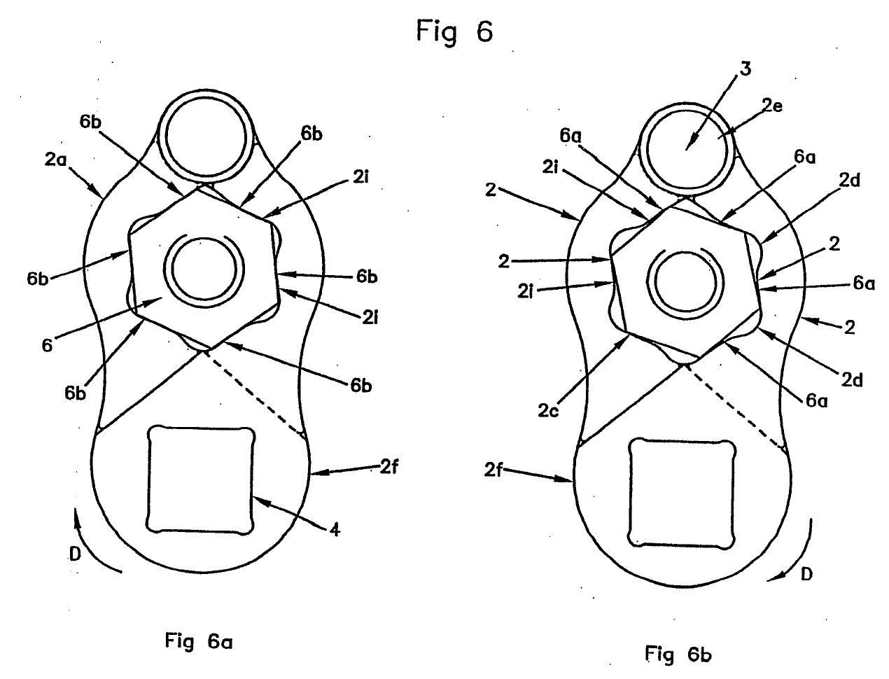

FIG. 6 shows the socket with an inner fastener drive surface designed for single direction use.

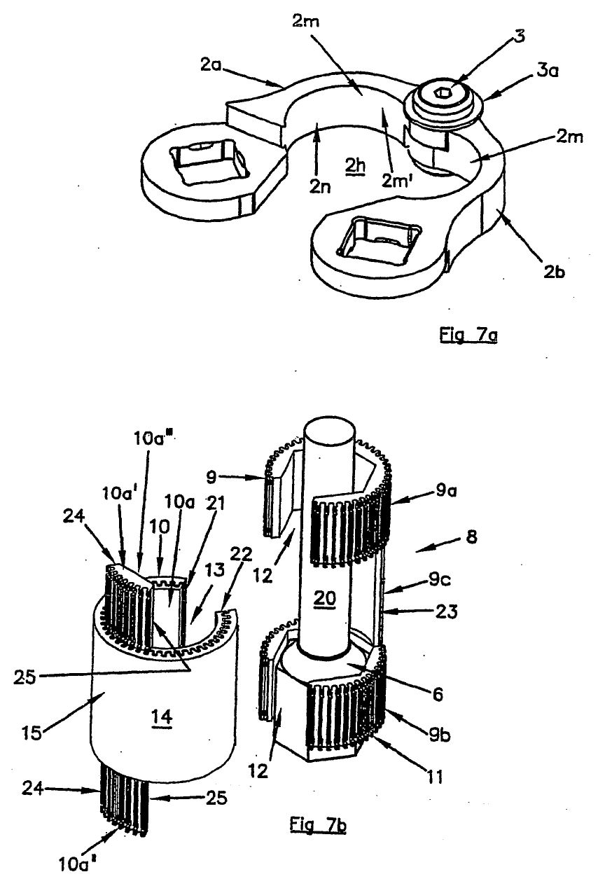

FIG. 7a shows a socket with an inner fastener drive surface for use in a ratchet mechanism;

FIG. 7b shows a fastener drive device in two separate parts for use with the socket of FIG. 7a;

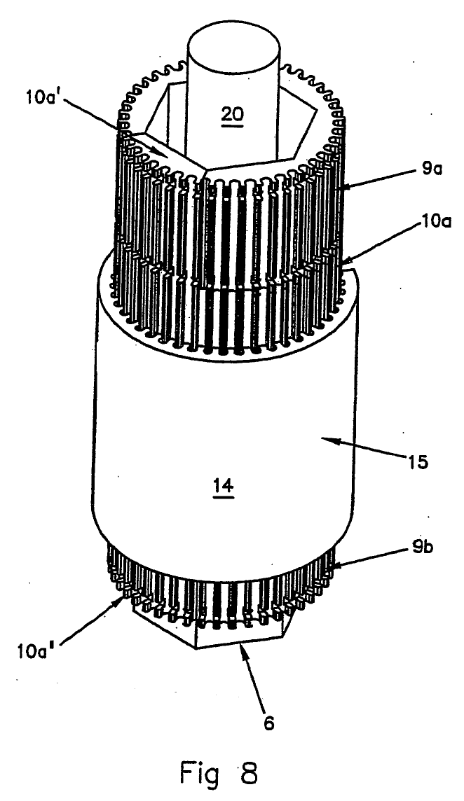

FIG. 8 shows the fastener drive device of FIG. 7b with the two parts joined together;

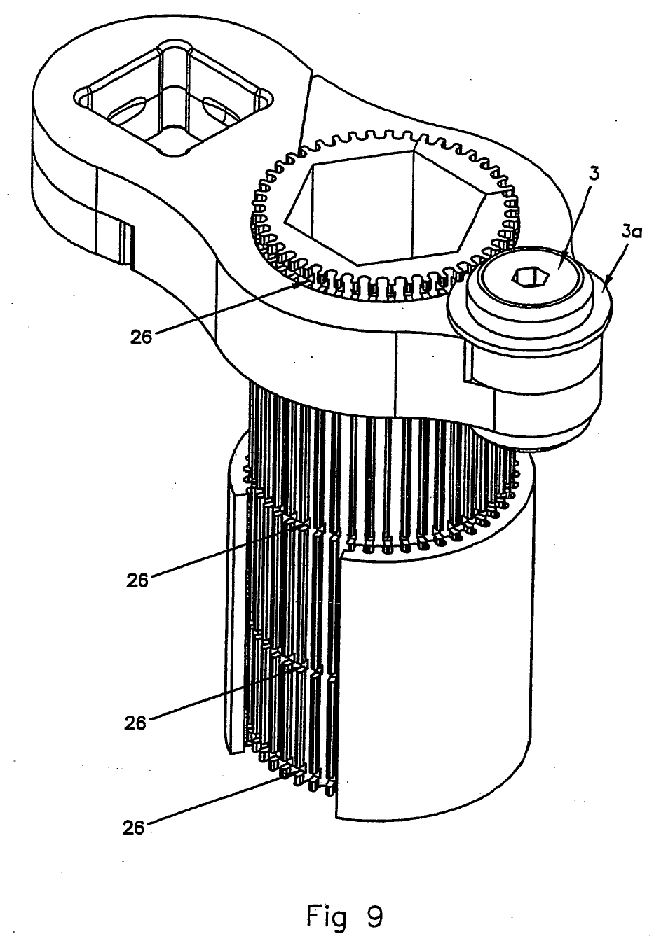

FIG. 9 shows in perspective the socket of FIG. 7a and fastener drive device of FIG. 8 locked together;

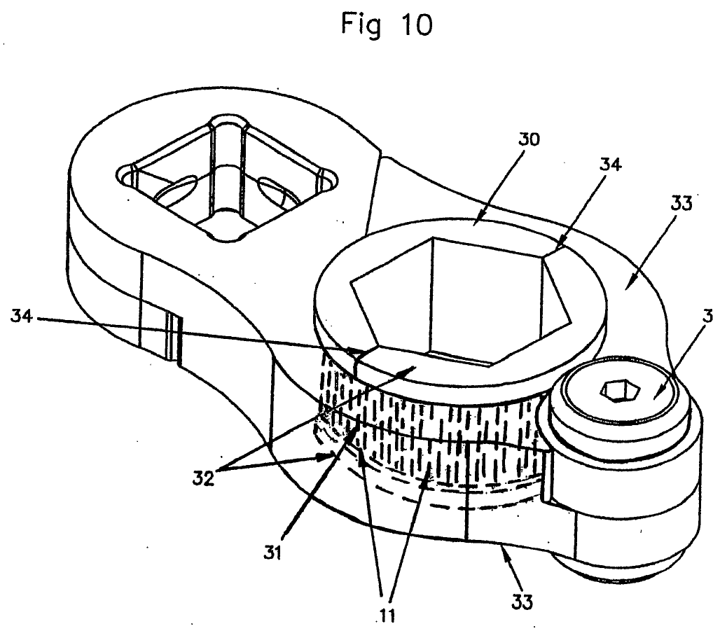

FIG. 10 shows in perspective an alternative embodiment of socket and fastener drive device;

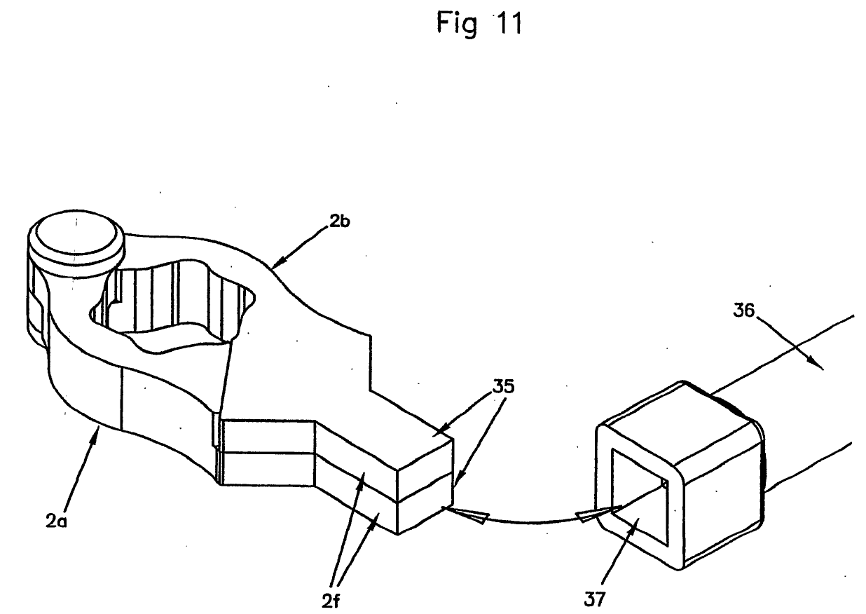

FIG. 11 shows in perspective another alternative embodiment of a socket and wrench drive; and

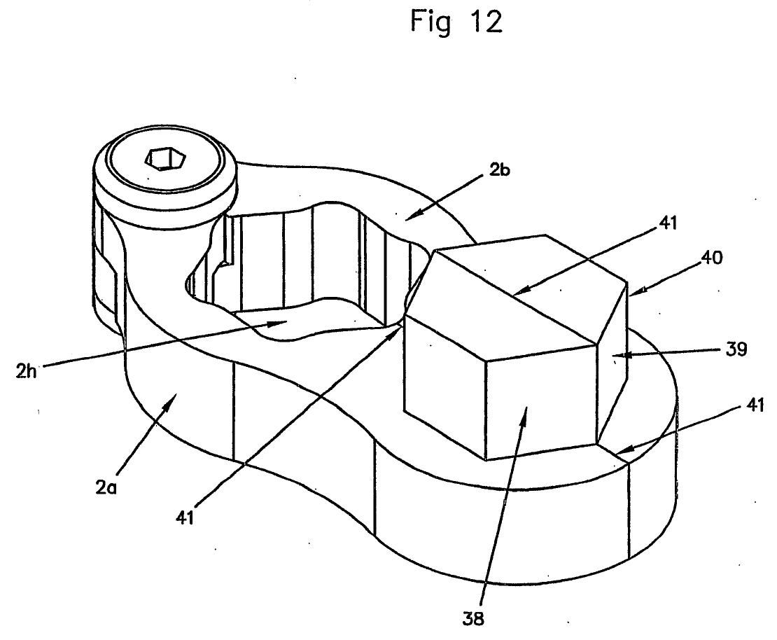

FIG. 12 shows in perspective a further embodiment of a socket.

### DESCRIPTION OF PREFERRED EMBODIMENTS

In the following specific description of one or more embodiments in accordance with the present invention, like features will be given like reference numbers throughout the drawings. The embodiments described herewith will be described with reference to FIGS. 1-3, and 5; FIG. 4; or FIG. 6.

FIG. 1 illustrates a socket (1) comprising a plurality of swivel jaw arms (2a, 2b) capable of pivotal movement in the same plane about an axis pin (3). The axis pin (3) securely fixes together swivel jaw aim (2a) and swivel jaw arm (2b) through axis pin apertures (2e) within swivel end (2g) of each swivel jaw arm (2a, 2b). End (2f) of each swivel jaw arm remote from the axis pin apertures (2e) incorporates a lock/drive portion illustrated as a rectangular, for example square, drive aperture (4). FIG. 2 shows that when the socket (1) is closed with apertures (4) in each arm (2a, 2b) overlying each other, as shown in FIGS. 1a, 1f and 2, a similarly sized drive spigot (5) to aperture (4) and forming part of a socket bar (5a), or any other similar drive means, engages into the lock/drive apertures (4) thereby locking the socket (1) closed about a fastener. Applying torque in the applied torque direction (D) to the socket (1) via a known socket bar drive (5a), tightens a fastener on which the socket (1) is mounted. Any other similar drive means may take any other operative cross-sectional shape which is engagable into the correspondingly shaped lock/drive apertures (4).

FIG. 3 shows in perspective, part of a vehicle suspension illustrating one use for the socket (1). Fastener (6) is in the form of a locking nut (6a) securing a tie rod (7a) in place relative to tie rod end (7b) which are part of a vehicle steering rack (7). The vehicle steering rack (7) is used to steer the vehicle and its correct length adjustment is crucial to both the safe handling of the vehicle and tyre (8) wear. It is well known that any steering rack (7) length adjustment is made by screwing the tie rod (7a) in or out relative to the tie rod end (7b).

FIG. 4 illustrates one alternative embodiment of the socket (1). In this embodiment the two arms (2a, 2b) are not directly interconnected by axis pin (3). A third arm (2j) is connected to the apertures (2e) of the arms (2a, 2b) by respective axis pins (3). Central aperture (2h) of the closed socket (1) in FIG. 4a has a plurality of drive surfaces (2c) (FIG. 4b). Two such drive surfaces (2c) are provided on the third arm (2j) and define surfaces of the aperture (2h). Angled junctions (2d) are defined between any two adjacent drive surfaces (2c). The aperture (2h) is of a hexagonal configuration. Aperture (2h) may have any other polygonal configuration. The lock/drive aperture (4) functions in a similar manner to that disclosed with reference to FIGS. 1 to 3, and 5.

In one example of the use of the socket (1) of FIG. 4 is the same as that shown in FIG. 3. The socket (1) is placed around fastener (6a) and the ends (2f) of arms (2a, 2b) brought together so that apertures (4) overlie each other to receive drive bar (5) of a torque wrench (5a). The socket (1) is operated in the desired manner by applying torque in a direction (D), to lock fastener (6) of an automotive tie rod end (7b) (known as a track rod end in the United Kingdom). The tie rod end (7b) being an end portion of a vehicle steering rack (7) attached to a plate upon which a wheel 8 is mounted. The vehicle steering track is adjustable by rotation of the tie rod (7a) relative to the tie rod end (7b). The drive spigot or bar (5) is shown as part of a socket bar or ratchet mechanism (5a).

As shown in FIG. 5, the socket (1) is designed for use on any fastener (6) for solid rod-like structures or pipe fittings (6c) (for example for any fluid such as hydraulic fluid, water, gas or air), whereas the fastener (6) or pipe fitting (6c) to be tightened or slackened is inaccessible by known closed ring wrenches or sockets because of “closed” pipe work or metal work (6d) obstructing the fitment of known closed ring wrenches or sockets.

As illustrated in FIG. 3, the socket (1) is particularly suitable for use in slackening or tightening the locking fastener (6) securing the tie rod end (7b). Tie rod (7a) fasteners (6) are subject to dirt and corrosion, which makes them particularly difficult to unlock, requiring considerable applied torque to unlock to allow adjustment or replacement of the tie rod end (7b).

The socket (1) is opened to pass around the pipe or metal work (6d) (FIG. 5) or the tie rod (7a) to engage fastener (6) so that these parts enter with ease into central aperture (2h) of the socket. The swivel arms (2a, 2b) swivel in the same plane around the axis pin or pins (3). When the socket is closed the apertures (4) align allowing a suitable spigot drive (5) to engage the apertures (4) locking the internal fastener drive surfaces (2c) close around the fastener (6) for operation thereof by socket bar (5a) or similar. Torque can then be applied in the appropriate direction to tighten or slacken the fastener as required. The socket design is inherently strong and with good manufacturing practises capable of exceeding any torque requirement for its function.

Referring now to FIGS. 6a, 6b the drive surfaces (2c) of the socket (1) are replaced by one directional drive surfaces (2i) which allow the use of the socket (1) over a greater range of fastener (6) sizes for any one size of socket. The drive surface (2i) is shaped so that its contact with the polygonal drive surface (6a) of the fastener 6 is via the parts of the fastener sides (6b) capable of transmitting torque in the direction D of applied torque (see FIG. 6b). Although the drive surfaces (2i) are capable of use in only one direction, the improved profile of the swivel jaw fastener drive surface (2i) allows other near sized fasteners (6) to be operated with confidence using the same socket. To use the socket (1) in the opposite direction to tighten a fastener (6) the socket is turned over.

As mentioned above ring wrenches and sockets are well known for slackening or tightening fasteners (6) or pipe fittings (6b). However, in certain circumstances known ring wrenches or sockets are impossible to use, because access to the peripheral surface (6b) of the fastener or pipe fitting (6) can be obstructed by closed metal work or pipe work (6d) (FIG. 5).

The described embodiments overcome these problems by having a plurality of swivel arms (2a, 2b) pivotally mounted in the same plane and fixed and secured together at a swivel end (2g) by an axis pin (3). These swivel arms (2a, 2b) advantageously open and close as required around an appropriately sized fastener (6) which is to be tightened or slackened. When the swivel arms (2a, 2b) are fully closed the lock/drive apertures (4) align with each other and an appropriate drive spigot (5) engages into the lock/drive apertures (4) to lock the swivel arms (2a, 2b) in a closed position around the polygonal drive surface of the fastener (6). Torque to drive the socket bar (5a) is applied in the applied torque direction (D) to tighten or slacken the fastener (6) as required.

In one alternative embodiment the ends of the arms or jaws (2a, 2b) may be of a rectangular shape so as to be engaged to by an open ended wrench or spanner instead of by the wrench bar 5a, to turn the socket and hence fastener as hereinbefore described. It is possible to combine this alternative configuration with the provision of apertures 4 so that the socket can be operated using a wider range of torque applying devices.

A further embodiment of the invention is shown in FIGS. 7 and 8 in which the socket is provided with a ratchet mechanism.

In this embodiment, the socket differs from that in the FIG. 1 embodiment in that the aperture (2h) between the two arms (2a, 2b) is defined by two semi-circular surfaces (2m) which, when the arms (2a, 2b) are closed, define cylindrical aperture (2h).

Respective teeth (2n) are located in the surfaces (2m′, 2m″). Alternatively, a tooth (2n) need only be provided in one surface (2m) with the other surface (2m″) having no tooth. As yet another alternative, each surface (2m′, 2m″) may include two or more teeth as will be described in more detail below. Each tooth is located in a recess, or slot, (not shown) within arm (2a, 2b) and is biased outwardly of the slot by any conventional spring, such as a helical or leaf type compression spring, also not shown.

Pivot (3) in FIG. 7a includes a washer (3a) of an enlarged diameter which projects over the peripheral edge of aperture (2h) as will be described below.

An elongate fastener drive device (8) is provided in two parts (9, 10) which interlock and in use are located within circular aperture (2h) of the socket. The part (9) of the drive device (8) comprises two coaxial axially spaced C-shaped portions (9a, 9b) joined by an axially extending intermediate portion (9c). Spaced portions (9a, 9b) and intermediate portion (9c) have a plurality of external teeth (11) extending in the axial direction of the fastener drive device.

The spaced portions (9a, 9b) are each substantially circular externally, but internally define five sides (12) of a hexagonal aperture for connection with a suitable sized fastening device. An opening (12) in each C-shaped portion (9a, 9b), corresponds in width to the width of the sides (12) hexagonal aperture.

The part (10) comprises a further C-shaped toothed portion (10a) has a plurality of elongate teeth (10b) extending in the lengthways direction of the part (10). Axially extending portions (10a′ and 10a″) extend oppositely from the toothed portion (10a) and have a width along an inner planar face (10a″) substantially equal to one face (12) and, therefore, to the opening (12) in C-shaped portions (9a, 9b).

An opening (13) in the C-shaped toothed portion (10a) is also similar in width to the width of the faces (12) and is disposed opposite the portions (10′and 10a″).

A C-shaped sleeve (14) has a plain external peripheral surface (15) and a toothed internal surface with the teeth arranged to interlock with the teeth on the external surface of toothed portion (10a) for sliding movement of the sleeve thereon. The axial length of both the toothed portion (10a) and the sleeve (14) is equal to the axial spacing between portions (9a, 9b).

In use, the socket of FIG. 7a and fastener drive device (8) of FIG. 7b are divided into their individual components as shown in FIGS. 7a, 7b. Fastener part (9) is initially placed over a pipe (20) by allowing the pipe to pass through apertures (12) in portions (9a, 9b). The fastener part (9) is then lowered axially along the pipe (20) until the hexagonal shaped inner surface of portion (9b) engages the fastener (6).

The fastener drive part (10) is then engaged with fastener drive part (9) by sliding the portion (10a) and sleeve (14) into the spacing between portions (9a, 9b) of fastener drive part (9). The opening (13) in the portion (10a) and sleeve (14) moves over the pipe (20) and edges (21, 22) of opening (13) engage with edges (23) (only one shown in FIG. 7b). Simultaneously, edges defining the openings (12) in portions (9a, 9b) engage with edges (24, 25) of axially extending portions (10a′, 10a″) of fastener drive part (10).

The sleeve (14) is then slid along the teeth (11) so as to overlap portions (9b and 10a) thereby interlocking parts (9 and 10) together as shown in FIG. 8.

Once the parts (9 and 10) are engaged as shown in FIG. 8, the swivel jaw arms (2a, 2b) of the socket are opened and the socket placed over the fastener drive device (8). The arms (2a, 2b) are closed until apertures (4) overlap and a spigot (5) of a wrench (5a) is inserted in both apertures (4) to lock the arms together around the fastener drive device.

In this position the tooth (2n) can engage in the respective grooves defined between adjacent teeth (11). The tooth (2n) is so shaped as to prevent rotation of the socket in one direction but allow rotation in an opposite direction thereby defining a ratchet mechanism. As the socket rotates about the fastener drive device (8), the tooth (2n) engages in each groove as it passes the tooth. When drive torque is to be applied to the fastener the tooth locks the socket relative to the drive device (8) to drive the fastener.

As previously mentioned, the socket may include two or more teeth (2n). When two or more teeth are used they may be positioned so that they all engage in grooves between teeth (11) at the same time to equalise pressure on the teeth (2n). Alternatively, the teeth may be displaced so that when one tooth engages a groove the next tooth (2n) engages the radially outermost surface of a tooth (11) centrally of that tooth (11). This results in a finer adjustment between the socket and drive device (8) because the socket is only required to move half the peripheral length between adjacent grooves of the teeth (11) before another tooth (2n) engages a groove to lock the socket and drive device (8) together for applying drive to a fastener.

Even finer adjustment to that just described can be achieved by introducing more teeth (2n) displaced at different locations relative to the width of a tooth (11).

Thereby, the socket and fastener drive device (8) have a ratchet mechanism which may have a minimum of one tooth width displacement or a much finer displacement depending on the number of teeth (2n) used and how teeth (2n) are located one relative to the other.

Axially spaced external circumferentially extending grooves (26) are provided around the fastener drive device (8). As shown in FIG. 9, the grooves (26) can receive the washer (3a) therein to lock the fastener drive device (8) against axial movement relative to the socket. The positioning of the socket relative to the drive device (8) can be adjusted by arranging for the washer (3a) to engage another one of the axially spaced grooves (26).

An alternative fastener drive ratchet mechanism (30) is shown in FIG. 10.

In FIG. 10 the socket for use with the ratchet mechanism (30) is essentially the same as that shown in FIGS. 7a to 9, other than the omission of the washer (3a).

The fastener drive device (30) comprises a cylindrical portion (31), a portion of which is shown in broken line in FIG. 10, having axially extending teeth (11) around its external peripheral surface. The axial length of the cylindrical portion (31) and teeth (11) is substantially the same as the axial depth of arms (2a, 2b). At each end of the cylindrical portion (31) there is a flange (32) which extends over faces (33) of the arms (2a, 2b) when the socket is closed about the drive device (30) to prevent movement of the drive device relative to the socket.

The drive device (30) has an internal hexagonal configuration to mate with a hexagonal fastener of similar size. The fastener drive device (30) is split along dividing line (34) to enable the fastening device to be located around a fastener (6).

In a further embodiment shown in FIG. 11, the remote ends (2f) of the arms (2a, 2b) are provided without the apertures (4) and instead have a rectangular end (35), which when the arms overlap are engagable by a wrench (36) having a corresponding shaped recess (37) for engaging the rectangular ends (35) of the socket to drive the socket. The internal surfaces of the socket defining aperture (2h) are the same as those described with reference to FIG. 6 and will not be described further. However, it is to be understood that the internal surfaces defining aperture (2h) can take the form of those of any of the other embodiments.

The socket of FIG. 12 illustrates yet another embodiment of the present invention which again is a variation of the socket shown in FIG. 6. However, in place of the apertures (4), each arm (2a, 2b) is provided with a portion (38, 39) of a post (40). The portions (38, 39) are divided along line (41) and together define a hexagonal external surface which can, for example, be engaged by a similarly sized ring spanner to apply a torque to the socket. The internal surfaces defining aperture (2h) can take the same form as that of any of the described embodiments.

As an alternative to the embodiment of FIG. 12, the remote ends of arms (2a, 2b) do not necessarily have to overlap. The opposing surface of each arm may simply abut along line 41 in FIG. 12. It will be appreciated that they do not need to abut, provided that when the socket engages a fastener, a suitable torque applying lever engages the post to secure the arms (2a, 2b) together and apply a drive torque.

Although the various embodiments differ, it is to be understood that all features are applicable to any and each of the embodiments disclosed herein where appropriate.

I claim:

1. A socket for operation by a torque applying device, comprising two arms connected for movement one relative to the other between a first position in which ends of the arms remote from the connection are spaced apart, and a second position in which co-operating portions of the ends of the arms remote from the connection are simultaneously engagable by the torque applying device to lock the arms together and secure a fastener drive surface defined between the arms.

2. A socket as claimed in claim 1, wherein each arm has a recessed portion so that when the arms are closed together, a part defining the recess of one arm is received in the recessed portion of the other arm.

3. A socket as claimed in claim 2, comprising recessed portions provided at the ends of the arms remote from the connection between the arms.

4. A socket as claimed in claim 3, comprising recessed portions located at a swivel connection between the two arms.

5. A socket as claimed in claim 1, wherein said cooperating portions of the two arms overlap in the same plane.

6. A socket as claimed in claim 1, wherein said fastener drive surface is polygonal.

7. A socket as claimed in claim 6, wherein said polygonally shaped drive surface comprises a plurality of faces, each face of the polygonal fastener drive surface being a planar surface.

8. A socket as claimed in claim 6, wherein the polygonally shaped fastener drive surface comprises a plurality of inwardly curved surfaces for engaging fasteners of various sizes with a single size polygonally shaped fastener drive surface.

9. A socket as claimed in claim 6, wherein the polygonally shaped fastener drive surface is hexagonal.

10. A socket as claimed in claim 1, wherein said cooperating portions comprise a polygonal aperture located in each arm at the remote end thereof.

11. A socket as claimed in claim 10, wherein the polygonal aperture is of a rectangular cross-section.

12. A socket as claimed in claim 10, wherein the polygonal shaped aperture is of a square cross-section.

13. A socket as claimed in claim 1, wherein the cooperating portions define a post having a polygonal external surface for engagement by a cooperably shaped portion of a torque applying device.

14. A socket as claimed in claim 14, wherein the post comprises two portions one located respectively on each remote end of the two arms.

15. A socket as claimed in claim 1, including a third arm located to connect the two arms at the opposite end thereof relative to their remote end.

16. A socket as claimed in claim 15, wherein the third arm defines two faces of the fastener drive surface.

17. A socket as claimed in claim 1, wherein the fastener drive surface of the socket is circular when the arms are closed for engaging a fastener drive device therein.

18. A socket as claimed in claim 17, wherein the fastener drive device comprises two parts separable one from the other.

19. A socket as claimed in claim 18, wherein the two parts comprise co-operating abutting surfaces.

20. A socket as claimed in claim 19, wherein one part of the fastener drive device comprises two C-section portions axially spaced by an intermediate portion of lesser peripheral length than the C-section portions.

21. A socket as claimed in claim 20, wherein another part of the fastener drive device comprises a C-section central portion and a portion of lesser peripheral length than the central portion extending from each axial length thereof, respectively.

22. A socket as claimed in claim 19, comprising a sleeve slidable along the fastener drive device when the two parts thereof are butted together to lock the two parts together.

23. A socket as claimed in claim 22, wherein the external surface of the fastener drive device comprises elongate axially extending teeth and the sleeve has internal elongate axially extending teeth for allowing the sleeve to slide axially along the fastener drive device.

24. A socket as claimed in claim 23, comprising a peripherally extending groove in the external surface of the fastener drive device for engagement by a co-operating member on the socket to prevent relative axial movement between the socket and fastener drive device.

25. A socket as claimed in claim 24, wherein the co-operating member is a washer mounted at the pivot of the arms and extends beyond a peripheral edge of the internal surface of the socket aperture into the groove of the fastener drive device when located in the socket aperture.

26. A socket as claimed in claim 24, comprising a plurality of peripherally extending grooves for determining the relative axial location between socket and fastener drive device.

27. A socket as claimed in claim 19, wherein the fastener drive device comprises a divided cylindrical configuration having a flange at each axial end thereof for securing the drive device within the socket without axial movement thereof.

28. A socket as claimed in claim 27, wherein the external peripheral surface of the fastener drive device between the flanges comprise a plurality of axially extending teeth.

29. A socket as claimed in claim 19, wherein the internal surface of the socket aperture comprises one or more radially movable teeth therein for engagement with the teeth of the fastening drive device to effect a ratchet mechanism therebetween.

30. A socket as claimed in claim 1, wherein the remote end of the arms are of a rectangular configuration for engagement by a wrench having a rectangular aperture therein for receiving both overlapping remote ends of the arms to drive the socket.

31. A wrench socket for use with a torque applying device, said socket comprising two jaws connected by at least one pivot connection to permit relative movement of the jaws between a closed position in which the jaws can cooperably engage a fastener therebetween for applying a torque to the fastener and open positions in which respective free ends of said jaws are spaced apart to permit objects to pass therebetween, said jaws comprising respective engagement portions for engagement by a said torque applying device arranged such that when engaged by a said torque applying device said jaws are held in said closed position and a torque applied by the torque applying device can be transmitted to a fastener held between the jaws.

32. A wrench socket as claimed in claim 31, further comprising a ratchet mechanism, said ratchet mechanism comprising a sleeve comprising a plurality of parts separable in the axial direction of the sleeve, said sleeve defining a polygonal recess therein for engaging a fastener and having a series of circumferentially spaced grooves disposed on an outer surface thereof and extending in said axial direction, and at least one pawl provided on a said arm for engaging with said grooves.

33. A wrench socket as claimed in claim 31, further comprising ratchet means, said ratchet means comprising pawl means carried by at least one said arm and split sleeve means to be held between said arms in said closed position, said sleeve means defining an internal polygonal surface for engaging a fastener and external ratchet tooth defining means for engagement by said pawl means.

34. A method of applying a torque to a fastener, said method comprising moving respective free ends of two pivotally connected jaws apart and positioning said jaws about said fastener, closing said jaws about said fastener such that said free ends are moved closer together and fitting a torque applying device to said jaws such that said free ends are secured together about the fastener and a torque applied by said torque applying device can be transmitted to said fastener.
